(19) United States
(12) Patent Application Publication
(10) Pub. No.: US 2024/0348772 A1
(43) Pub. Date: Oct. 17, 2024

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Wenyi WANG, Beijing (CN); Yingzhan Xu, Beijing (CN); Kai Zhang, Los Angeles, CA (US); Li Zhang, Los Angeles, CA (US)

(21) Appl. No.: 18/674,691

(22) Filed: May 24, 2024

Related U.S. Application Data
(63) Continuation of application No. PCT/CN2022/133913, filed on Nov. 24, 2022.

(30) Foreign Application Priority Data
Nov. 24, 2021 (WO) PCT/CN2021/132734

(51) Int. Cl. H04N 19/105; H04N 19/139; H04N 19/172; H04N 19/597

(52) U.S. Cl. CPC H04N 19/105; H04N 19/139; H04N 19/172; H04N 19/597

(57) ABSTRACT

Embodiments of the present disclosure provide a solution for point cloud coding. A method for point cloud coding is proposed. The method comprises: determining, during a conversion between a current frame of a point cloud sequence and a bitstream of the point cloud sequence, at least one neighbor list comprising a set of neighbor points of a current point of the current frame based on geometry information of the set of neighbor points; and performing the conversion based on the at least one neighbor list. Compared with the conventional solution, the proposed method can advantageously improve the point cloud coding efficiency and coding quality.

### CROSS-REFERENCE TO RELATED APPLICATIONS

This application is a continuation of International Application No. PCT/CN2022/133913, filed on Nov. 24, 2022, which claims the benefit of International Application No. PCT/CN2021/132734, filed on Nov. 24, 2021. The entire contents of these applications are hereby incorporated by reference in their entireties.

### FIELD

Embodiments of the present disclosure relates generally to video coding techniques, and more particularly, to attribute prediction for point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, during a conversion between a current frame of a point cloud sequence and a bitstream of the point cloud sequence, at least one neighbor list comprising a set of neighbor points of a current point of the current frame based on geometry information of the set of neighbor points; and performing the conversion based on the at least one neighbor list. The method in accordance with the first aspect of the present disclosure determines at least one neighbor list based on geometry information, and thus can improve the efficiency of the prediction for the point cloud coding.

In a second aspect, another method for point cloud coding is proposed. The method comprises: determining, during a conversion between a current frame of a point cloud sequence and a bitstream of the point cloud sequence, a list of predictor candidates of a current point of the current frame; determining whether to add a potential candidate into the list of predictor candidates; in accordance with a determination to add the potential candidate, updating the list of predictor candidates by adding the potential candidate; and performing the conversion based on the list of predictor candidates. The method in accordance with the second aspect of the present disclosure updating the predictor candidate list by determining whether to add a potential candidate into the list, and thus can obtain a proper predictor candidate list for the prediction of the point cloud coding.

In a third aspect, another method for point cloud coding is proposed. The method comprises: determining, during a conversion between a current frame of a point cloud sequence and a bitstream of the point cloud sequence, a real maximum candidate index of a prediction list of a current point of the current frame; including the real maximum candidate index in the bitstream; and performing the conversion based on the including. The method in accordance with the third aspect of the present disclosure including the real maximum candidate index of the prediction list in the bitstream, and thus can improve the efficiency of point cloud coding.

In a fourth aspect, another method for point cloud coding is proposed. The method comprises: determining, during a conversion between a current frame of a point cloud sequence and a bitstream of the point cloud sequence, a selected neighbor point of a current point of the current frame; determining a predicted attribute of the current point based on an attribute of the selected neighbor point; and performing the conversion based on the predicted attribute. The method in accordance with the fourth aspect of the present disclosure determines the attribute of a selected neighbor point as a predicted attribute of the current point, and thus can improve the efficiency of point cloud coding.

In a fifth aspect, another method for point cloud coding is proposed. The method comprises: determining, during a conversion between a current frame of a point cloud sequence and a bitstream of the point cloud sequence, a prediction list of a current point of the current frame; determining a set of predictor candidates of the current point by obtaining a value set based on attributes of points in the prediction list; determining respective predictor indexes for the set of predictor candidates; and performing the conversion based on the set of predictor candidates. The method in accordance with the fifth aspect of the present disclosure determines a value set based on attributes of points in the prediction list as predictor candidates, and thus can improve the efficiency of point cloud coding.

In a sixth aspect, another method for point cloud coding is proposed. The method comprises: determining, during a conversion between a current frame of a point cloud sequence and a bitstream of the point cloud sequence, a neighbor point of a current point of the current frame; determining a weighted average value of the neighbor point and an opposite point of the neighbor point as a predictor candidate of the current point, the opposite point being in a direction range opposite to a direction range of the neighbor point; and performing the conversion based on the predictor candidate. The method in accordance with the sixth aspect of the present disclosure determines the weighted average value of the neighbor point and an opposite point as a predictor candidate of the current point, and thus can improve the efficiency of point cloud coding.

In a seventh aspect, an apparatus for processing point cloud sequence is proposed. The apparatus for processing point cloud sequence comprises a processor and a non-transitory memory with instructions thereon. The instructions upon execution by the processor, cause the processor to perform a method in accordance with the first, second, third, fourth, fifth or sixth aspect of the present disclosure.

In an eighth aspect, a non-transitory computer-readable storage medium is proposed. The non-transitory computer-readable storage medium stores instructions that cause a processor to perform a method in accordance with the first, second, third, fourth, fifth or sixth aspect of the present disclosure.

In a ninth aspect, a non-transitory computer-readable recording medium is proposed. The non-transitory computer-readable recording medium stores a bitstream of a point cloud sequence which is generated by a method performed by a point cloud sequence processing apparatus. The method comprises: determining at least one neighbor list comprising a set of neighbor points of a current point of a current frame of the point cloud sequence based on geometry information of the set of neighbor points; and generating the bitstream based on the at least one neighbor list.

In a tenth aspect, a method for storing a bitstream of a point cloud sequence is proposed. The method comprises: determining at least one neighbor list comprising a set of neighbor points of a current point of a current frame of the point cloud sequence based on geometry information of the set of neighbor points; generating the bitstream based on the at least one neighbor list; and storing the bitstream in a non-transitory computer-readable recording medium.

In an eleventh aspect, another non-transitory computer-readable recording medium is proposed. The non-transitory computer-readable recording medium stores a bitstream of a point cloud sequence which is generated by a method performed by a point cloud sequence processing apparatus. The method comprises: determining a list of predictor candidates of a current point of a current frame of the point cloud sequence; determining whether to add a potential candidate into the list of predictor candidates; in accordance with a determination to add the potential candidate, updating the list of predictor candidates by adding the potential candidate; and generating the bitstream based on the list of predictor candidates.

In a twelfth aspect, another method for storing a bitstream of a point cloud sequence is proposed. The method comprises: determining a list of predictor candidates of a current point of a current frame of the point cloud sequence; determining whether to add a potential candidate into the list of predictor candidates; in accordance with a determination to add the potential candidate, updating the list of predictor candidates by adding the potential candidate; generating the bitstream based on the list of predictor candidates; and storing the bitstream in a non-transitory computer-readable recording medium.

In a thirteenth aspect, another non-transitory computer-readable recording medium is proposed. The non-transitory computer-readable recording medium stores a bitstream of a point cloud sequence which is generated by a method performed by a point cloud sequence processing apparatus. The method comprises: determining a real maximum candidate index of a prediction list of a current point of a current frame of the point cloud sequence; including the real maximum candidate index in the bitstream; and generating the bitstream based on the including.

In a fourteenth aspect, another method for storing a bitstream of a point cloud sequence is proposed. The method comprises: determining a real maximum candidate index of a prediction list of a current point of a current frame of the point cloud sequence; including the real maximum candidate index in the bitstream; generating the bitstream based on the including; and storing the bitstream in a non-transitory computer-readable recording medium.

In a fifteenth aspect, another non-transitory computer-readable recording medium is proposed. The non-transitory computer-readable recording medium stores a bitstream of a point cloud sequence which is generated by a method performed by a point cloud sequence processing apparatus. The method comprises: determining a selected neighbor point of a current point of a current frame of the point cloud sequence; determining a predicted attribute of the current point based on an attribute of the selected neighbor point; and generating the bitstream based on the predicted attribute.

In a sixteenth aspect, another method for storing a bitstream of a point cloud sequence is proposed. The method comprises: determining a selected neighbor point of a current point of a current frame of the point cloud sequence; determining a predicted attribute of the current point based on an attribute of the selected neighbor point; generating the bitstream based on the predicted attribute; and storing the bitstream in a non-transitory computer-readable recording medium.

In a seventeenth aspect, another non-transitory computer-readable recording medium is proposed. The non-transitory computer-readable recording medium stores a bitstream of a point cloud sequence which is generated by a method performed by a point cloud sequence processing apparatus. The method comprises: determining a prediction list of a current frame of a point cloud sequence; determining a set of predictor candidates of the current point by obtaining a value set based on attributes of points in the prediction list; determining respective predictor indexes for the set of predictor candidates; and generating the bitstream based on the set of predictor candidates.

In an eighteenth aspect, another method for storing a bitstream of a point cloud sequence is proposed. The method comprises: determining a prediction list of a current frame of a point cloud sequence; determining a set of predictor candidates of the current point by obtaining a value set based on attributes of points in the prediction list; determining respective predictor indexes for the set of predictor candidates; generating the bitstream based on the set of predictor candidates; and storing the bitstream in a non-transitory computer-readable recording medium.

In a nineteenth aspect, another non-transitory computer-readable recording medium is proposed. The non-transitory computer-readable recording medium stores a bitstream of a point cloud sequence which is generated by a method performed by a point cloud sequence processing apparatus. The method comprises: determining, a neighbor point of a current point of a current frame of the point cloud sequence; determining a weighted average value of the neighbor point and an opposite point of the neighbor point as a predictor candidate of the current point, the opposite point being in a direction range opposite to a direction range of the neighbor point; and generating the bitstream based on the predictor candidate.

In a twentieth aspect, another method for storing a bitstream of a point cloud sequence is proposed. The method comprises: determining, a neighbor point of a current point of a current frame of the point cloud sequence; determining a weighted average value of the neighbor point and an opposite point of the neighbor point as a predictor candidate of the current point, the opposite point being in a direction range opposite to a direction range of the neighbor point; generating the bitstream based on the predictor candidate; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder in accordance with some embodiments of the present disclosure;

FIG. 3 illustrates a block diagram that illustrates an example point cloud decoder in accordance with some embodiments of the present disclosure;

FIG. 4 illustrates an example of coding flow for the optimized nearest neighbors search-based point cloud attribute prediction in accordance with some embodiments of the present disclosure;

FIG. 5 illustrates an example of coding flow for predicting the current point attribute by the attribute of nearest neighbor in accordance with some embodiments of the present disclosure;

FIG. 6 illustrates a flowchart of a method for point cloud coding in accordance with some embodiments of the present disclosure;

FIG. 7 illustrates a flowchart of another method for point cloud coding in accordance with some embodiments of the present disclosure;

FIG. 8 illustrates a flowchart of another method for point cloud coding in accordance with some embodiments of the present disclosure;

FIG. 9 illustrates a flowchart of another method for point cloud coding in accordance with some embodiments of the present disclosure;

FIG. 10 illustrates a flowchart of another method for point cloud coding in accordance with some embodiments of the present disclosure;

FIG. 11 illustrates a flowchart of a method for point cloud coding in accordance with some embodiments of the present disclosure; and

FIG. 12 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

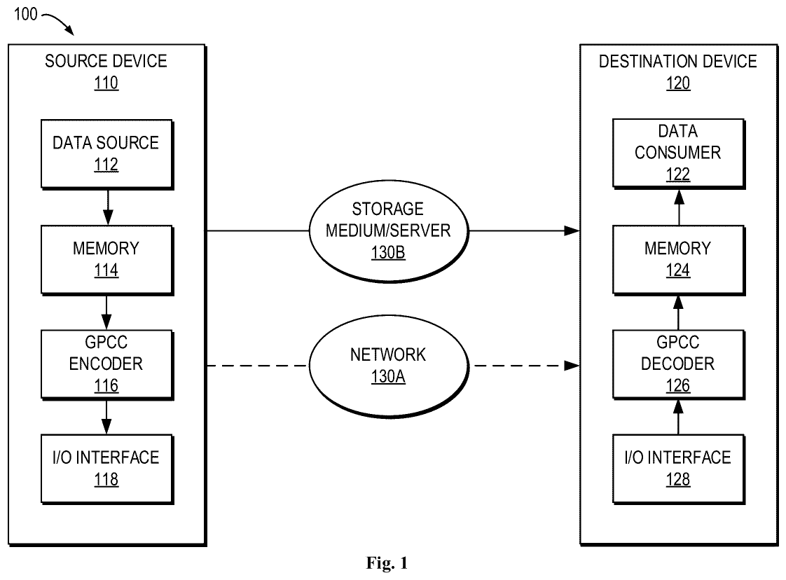

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

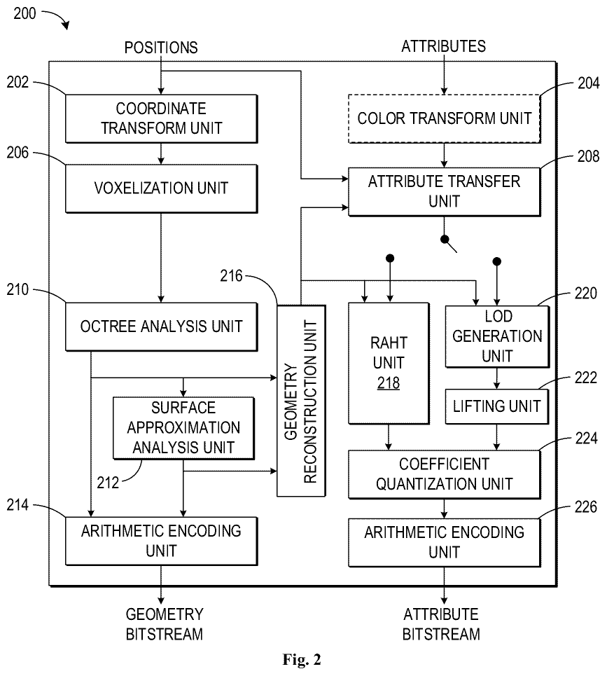

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Summary

This disclosure is related to point cloud coding technologies. Specifically, it is related to point cloud attribute prediction in intra prediction. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
LOD Level of Detail
APS Attribute Parameter Set

### 3. Background

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on. Point cloud codec can process the various information in different ways. Usually there are many optional tools in the codec to support the coding and decoding of geometry information and attribute information respectively.

In G-PCC, geometry information is compressed before attribute information. In other words, attribute information has been already known when attribute information is encoded. So, geometry information can be used to help compress attribute information. In order to compress attribute information, two attribute coding methods predicting transform and lifting transform have been proposed. They all leverage geometry information to compress attribute information.

### 3.1 Predicting Transform

Predicting transform is an interpolation-based hierarchical nearest neighbors prediction method, which is typically used for sparse point cloud content. Predicting transform depends on level of detail (LOD) structure. And it comprises 1) LOD generation, 2) nearest neighbors search considering point distribution and 3) attribute prediction.

### 3.1.1 LOD Generation

In the LOD generation process, the geometry information is then leveraged to build a hierarchical structure of the point cloud, which defines a set of “level of details”. The hierarchical structure is exploited in order to efficiently predict attributes. It also makes it possible to provide advanced functionalities such as progressive transmission and scalable rendering. The LOD generation process re-organizes the point cloud points into a set of refine level (points set) R₀, R₁, . . . , R_{L-1} according to the user-defined parameter L which indicates LOD number. Then the attribute of point cloud points will be encoded from R₀ to R_{L-1}. The level of detail l, LODₗ, can be obtained by taking the union of the refinement levels R₀, R₁, . . . , Rₗ:

$$L O {D}_{l} = {R}_{0} ⋃ {R}_{1} ⋃ … ⋃ {R}_{l} \qquad ( 3 - 1 )$$

### 3.1.2 Nearest Neighbors Search Considering Point Distribution

In order to consider both distance and point distribution, G-PCC build two neighbor lists list 1 and list 2 to search 3 approximately nearest neighbors of the current point at most. List 1 contains 3 approximately nearest neighbors which are obtained by a LOD based approximately nearest neighbors search algorithm. List 2 contains 3 points that are dropped out when updating list 1. In order to using point distribution information, the concept of strict opposite and loose opposite is defined. According to the relative position with the current point (x, y, z), every nearest neighbor point (xₙ, yₙ, zₙ) is assigned to a direction index dirIdx. The direction index dirIdx is computed as the following formula:

$${d}_{x} = \{ \begin{matrix}0 , & {x}_{n} \geq x \\ 1 , & {x}_{n} < x\end{matrix} \qquad ( 3 - 2 )$$

$${d}_{y} = \{ \begin{matrix}0 , & {y}_{n} \geq x \\ 1 , & {y}_{n} < x\end{matrix} \qquad ( 3 - 3 )$$

$${d}_{z} = \{ \begin{matrix}0 , & {z}_{n} \geq x \\ 1 , & {z}_{n} < x\end{matrix} \qquad ( 3 - 4 )$$

$$dirIdx = {d}_{x} ≪ 2 + {d}_{y} ≪ 1 + {d}_{z} \qquad ( 3 - 5 )$$

The << is bitwise left shift operator. According to the direction index dirIdx, strict opposite and loose opposite are defined as Table 1.

TABLE 1
the definition strict opposite and loose
opposite according direction index dirIdx

| strict opposite | loose opposite |
|---|---|
| 0 ↔ 7 | 0 ↔ 3, 5, 6 |
| 1 ↔ 6 | 1 ↔ 2, 4, 7 |
| 2 ↔ 5 | 2 ↔ 1, 4, 7 |
| 3 ↔ 4 | 3 ↔ 0, 5, 6 |
| — | 4 ↔ 1, 2, 7 |
| — | 5 ↔ 0, 3, 6 |
| — | 6 ↔ 0, 3, 5 |
| — | 7 ↔ 1, 2, 4 |

The final neighbor list is generated by updating list 1 using points in list 2 as a strict opposite eligibility check and a loose opposite eligibility check. Note that the point number of final list 1 may be less than 3 because there are not enough neighbors, and a neighbor pruning process will be performed.

### 3.1.3 Attribute Prediction

After obtaining final neighbor list list1, multiple predictor candidates are created based on list1 and two parameters in attribute parameter set (APS) which stores the parameters that control the attribute coding tools. The two parameters are pred_direct_max_idx which specifies the maximum number of list1 and pred_direct_avg_disabled_flag which specifies whether neighborweighted average prediction is selectable as a predictor candidate or not. If pred_direct_avg_disabled_flag is equal to 0, weighted average value of all neighbors attribute in list1 is set to predictor index equal to 0 and the attribute of n-th nearest neighbor point in list1 is set to predictor index equal to n. If pred_direct_avg_disabled_flag is equal to 1, neighborweighted average prediction is not selectable as a predictor candidate and the attribute of n-th nearest neighbor point in list1 is set to predictor index equal to n−1. Table 2 and Table 3 show the relation between predictor candidates and predictor index when pred_direct_avg_disabled_flag is equal to 0 and 1 separately.

TABLE 2
predictor candidates for attributes coding
(pred_direct_avg_disabled_flag = 0)

| Predictor index | Predictor |
|---|---|
| 0 | weighted average |
| 1 | 1st nearest point |
| . . . | . . . |
| n | n-th nearest point |
| . . . | . . . |

TABLE 3
predictor candidates for attributes coding
(pred_direct_avg_disabled_flag = 1)

| Predictor index | Predictor |
|---|---|
| 0 | 1st nearest point |
| . . . | . . . |
| n-1 | n-th nearest point |
| . . . | . . . |

After creating predictor candidates, the variability of neighbors attributes in list1 is computed to check how different the neighbors attributes are. If the variability is less than a threshold, the weighted average value will be used to predict the current point attribute. Otherwise, the best predictor is selected by applying a rate-distortion optimization procedure and then, selected predictor index is signaled according to max candidate index decided by pred_direct_max_idx and pred_direct_avg_disabled_flag.

### 3.1 Lifting Transform

The lifting transform is typically used for dense point cloud content and builds on top of the predicting transform. In lifting transform, each point is associated with an influence weight. Points in lower LOD are used more often and, therefore, impact the encoding process more significantly. The influence weight will be used to guide the quantization processes. The main difference is the lifting transform introduces an update operator and uses an adaptive quantization strategy.

### 4. Problems

The existing designs for point cloud attribute prediction based on the nearest neighbors search have the following problems:
1. In current G-PCC, only the points that are dropped out when updating list 1 are used to build list 2. However, a nearer neighbor point whose attributes is more relative with current point may be missed. Moreover, the point distribution is not considered when building list 2.
2. In current G-PCC, the weighted average value or one of the neighbor attributes are used to create predictor candidates without removing the duplicate values. However, if there is duplicate value among predictor candidates, it will result in redundancy of predictor index signaling.
3. In current G-PCC, the max candidate index for predictor is decided by pred_direct_max_idx and pred_direct_avg_disabled_flag. However, if point number of list 1 is less than pred_direct_max_idx, the real max candidate index is much smaller. In this case, deciding max candidate index by pred_direct_max_idx and pred_direct_avg_disabled_flag is inefficient.

### 5. Details Description

In this disclosure, it is proposed to improve the point cloud attribute prediction algorithm based on the nearest neighbors search in G-PCC. Firstly, it is considered to directly use the nearest neighbor in eight directions to construct list 2, thus can better find nearest neighbor in every direction and consider all directions of the nearest neighbor distribution more comprehensively. Secondly, duplicate value of predictor candidates is removed to avoid redundancy of predictor index signaling. Thirdly, predictor index according to the real max candidate index is signaled. Thus, the predictor index can be compressed more efficiently. Last, nearest neighbors are used to predict current point attribute, which is more appropriate to some point cloud content under lossless compress condition.

In the following description, list 1 may be the list which stores the nearest neighbors and list 2 may be the list which stores the points to update list 1.

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.
1) At least one specific list (such as list 2) may be built with a set of neighbor points, which may be selected based on geometry information, such as distance between a neighbor point and the current point.
   a. Alternatively, furthermore, the neighbor points of the specific lists may be used to update the nearest neighbors candidate list (such as list 1).
   b. In one example, the nearest neighbors from different directions may be used to build the specific list.
      i. In one example, the nearest neighbors may be the neighbor points which has the nearest distance to the current point.
         1. In one example, the distance is defined as Euclidean distance, Manhattan distance, Chebyshev distance and so on.
   c. In one example, for at least one neighbor point, one vector direction may be derived for the current point.
      i. In one example, the vector direction may be derived by calculating the difference between the neighbor point coordinate and the current point coordinate.
   d. In one example, the points may be clustered into one or multiple clusters based on their vector directions.
      i. In one example, each cluster may be corresponding to one direction.
      ii. In one example, a point may be clustered in a cluster according to the point's vector direction, where the cluster may just keep the nearest neighbors of one direction.
   e. In one example, the nearest neighbors in at least one cluster may be used to build the specific list.
      i. Alternatively, the points in the nearest neighbors candidate list may be removed from the specific list, where the nearest neighbors candidate list is the list containing nearest neighbors from all candidate search points, such as list 1.
   f. In one example, the points of the specific list may be sorted by distances.
      i. Alternatively, furthermore, the sorted points are used to update the nearest neighbors candidate list, and the higher in order, the higher the priority.
   g. In one example, the points to build the specific list may come from all candidate search points.
   h. Alternatively, the points to build the specific list may come from points that are dropped out when updating another list (such as list 1).
   i. In one example, the distance between one point and the current point may be calculated as Euclidean distance, Manhattan distance, Chebyshev distance and so on.
2) A list of predictor candidates may be created by checking at least one potential candidate to determine whether it is qualified to be put into the list (called pruning process).
   a. In one example, the potential candidate may be compared with at least one candidate already in the list.
   b. In one example, the potential candidate may be determined not to be put into the list if it is identical to (or similar to) at least one candidate already in the list.
   c. The predictor candidate may be an attribute prediction or a geometry prediction.
   d. In one example, for single dimension attribute prediction, such as reflectance, it is determined to be identical to or similar to another attribute prediction by comparing the single dimension.
   e. In one example, for single dimension attribute prediction, such as color, it is determined to be identical to or similar to another attribute prediction by comparing one of, or some of, or all of the dimensions.
   f. In one example, for single dimension attribute, such as reflectance, if the attribute values of multiple predictors are equal, only one may be reserved.
   g. In one example, for multiple dimensions attribute, such as color, if every dimension of the attribute values of multiple predictors are equal, only one may be reserved.
3) The predictor index may be signaled according to the real maximum candidate index.
   a. In one example, the real maximum candidate index maxCanIdx may be decided by the point number N of a prediction list (such as list 1), and/or pred_direct_max_idx and/or pred_direct_avg_disabled_flag.
      i. In one example, maxCanIdx may be decided by following formula:

$$maxCanIdx = min ( N , pred\_direct \_max \_idx ) + pred\_direct \_avg \_disabled \_flag . \qquad ( 5 - 1 )$$

min( ) is a function that obtain the minimum of two numbers.
b. Alternatively, if predictor candidates are created with the pruning process, the real maximum candidate index may be the number of predictor candidates minus K, K is an integer such as 1.
c. In one example, the predictor index may be signaled with fixed-length coding which the bits length is determined by the real maximum candidate index.
d. In one example, the predictor index may be signaled with truncated unary coding which the maximum value is determined by the real maximum candidate index.
e. In one example, the predictor index may be signaled joint with other signals, such as attribute residuals.
4) The attribute of the current point may be directly predicted by the attribute of a selected neighbor.
   a. In one example, the selected point may be selected by searching a set of candidate search points.
      i. In one example, the search may be based on the Euclidean distance.
      ii. In one example, the search may be based on the Manhattan distance.
      iii. In one example, the search may be based on the Chebyshev distance.
      iv. In one example, the point with the minimal distance may be selected.
   b. Alternatively, the selected neighbor may be selected from a set of points that have been signaled.
5) A value set equal to the output of a function of the attributes of the points in a list (such as list 1) may be used as a predictor candidate which is set to a different predictor index.
   a. In one example, the function may be a median function.
   b. In one example, the value may be used as a predictor.
   c. In one example, there may be one predictor index referring to the value.
      i. In one example, the predictor index may be a non-negative integer.
      ii. In one example, if predictor candidates are created with the pruning process, the real maximum candidate index may be the number of predictor candidates minus K, K is an integer such as 1.
6) The weighted average value of the selected neighbor and its strict opposite point may be used as a predictor candidate which is set to a different predictor index.
   a. The selected neighbor may be the nearest neighbor.
   b. In one example, the weight used to compute average value may be the reciprocal of Euclidean distance. The Euclidean distance d of two points (x₁, y₁, z₁) and (x₂, y₂, z₂) is computed as the following formula:

$$d = \sqrt{{a ( {x}_{1} - {x}_{2} )}^{2} + {b ( {y}_{1} - {y}_{2} )}^{2} + c {( {z}_{1} - {z}_{2} )}^{2}} , \qquad ( 5 - 2 )$$

where a, b and c are factors representing the importance of different dimension.
c. In one example, the weight used to compute average value may be the reciprocal of Manhattan distance. The Manhattan distance d of two points (x₁, y₁, z₁) and (x₂, y₂, z₂) is computed as the following formula:

$$d = a \vert {x}_{1} - {x}_{2} \vert + b \vert {y}_{1} - {y}_{2} \vert + c \vert {z}_{1} - {z}_{2} \vert , \qquad ( 5 - 3 )$$

where a, b and c are factors representing the importance of different dimension.
d. In one example, the weight used to compute average value may be the reciprocal of Chebyshev distance. The Chebyshev distance d of two points (x₁, y₁, z₁) and (x₂, y₂, z₂) is computed as the following formula:

$$d = max ( a \vert {x}_{1} - {x}_{2} \vert , b \vert {y}_{1} - {y}_{2} \vert , c \vert {z}_{1} - {z}_{2} \vert ) , \qquad ( 5 - 4 )$$

where a, b and c are factors representing the importance of different dimension and max( ) a function that obtain the maximum of three numbers.
e. In one example, an output the weighted average value may be used as a predictor.
f. In one example, there may be one predictor index referring to the weighted value.
   i. In one example, the predictor index may be a non-negative integer.
   ii. In one example, if predictor candidates are created with removing duplicated values, the predictor index may be a positive integer.

### 6. Embodiments

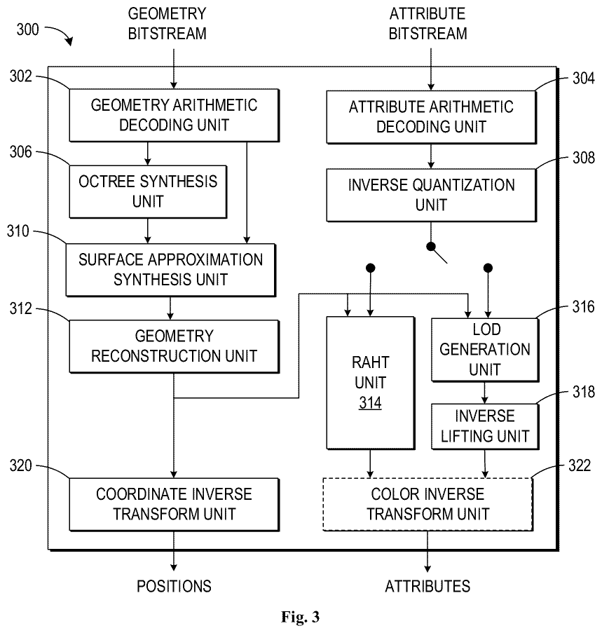

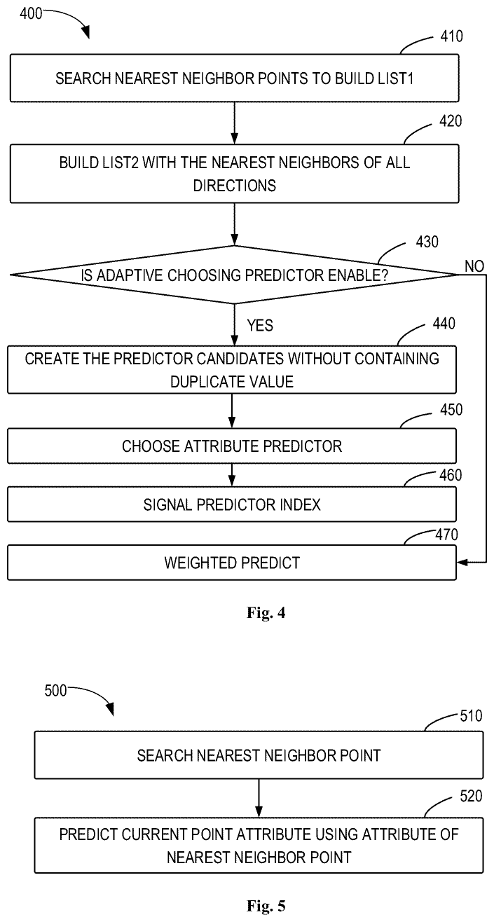

An example of the coding flow 400 for the optimized the nearest neighbors search based point cloud attribute prediction method is depicted in FIG. 4. As shown in FIG. 4, at block 410, nearest neighbor points are searched to build list 1. At block 420, list 2 is built with the nearest neighbors of all directions. At block 430, it is determined whether adaptive choosing predictor is enabled. If it is determined that adaptive choosing predictor is enabled at block 430, the predictor candidates are created without containing duplicate value at block 440. At block 450, attribute predictor is chosen. At block 460, predictor index is signaled. If it is determined that adaptive choosing predictor is disabled at block 430, a weighted predict is performed at block 470.

Consider bullet 4 in section 5, current point attribute can be directly predicted by the attribute of nearest neighbor. FIG. 5 illustrates an example of coding flow 500 for predicting the current point attribute by the attribute of nearest neighbor in accordance with some embodiments of the present disclosure. At block 510, a nearest neighbor point is searched. At block 520, current point attribute is predicted by using attribute of the nearest neighbor point.

As used herein, list 1 (also referred to as list1) may be the list which stores the nearest neighbors and list 2 (also referred to as list2) may be the list which stores the points to update list 1.

The embodiments of the present disclosure are related to motion information coding for point cloud coding. As used herein, the term “point cloud sequence” may refer to a sequence of one or more point clouds. The term “frame” may refer to a point cloud in a point cloud sequence. The term “point cloud” may refer to a frame in the point cloud sequence.

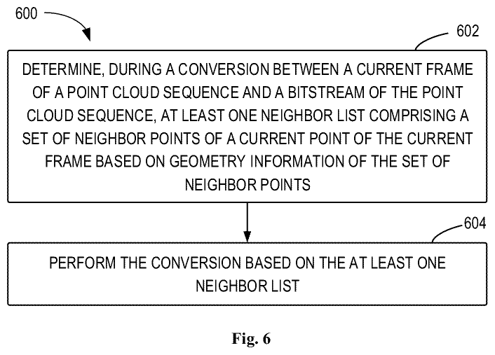

FIG. 6 illustrates a flowchart of method 600 for point cloud coding in accordance with some embodiments of the present disclosure. The method 600 may be implemented during a conversion between a current frame of a point cloud sequence and a bitstream of the point cloud sequence. As shown in FIG. 6, the method 600 starts at block 602, where at least one neighbor list comprising a set of neighbor points of a current point of the current frame is determined based on geometry information of the set of neighbor points. The at least one neighbor list may comprise the list 2 described in the section 3. By determining the at least one neighbor list based on geometry information, the coding efficiency can be improved.

At block 604, the conversion is performed based on the at least one neighbor list. In some embodiments the conversion may include encoding the current frame into the bitstream. Alternatively, or in addition, the conversion may include decoding the current frame from the bitstream.

In some example embodiments, the geometry information for a neighbor point in the set of neighbor points comprises a distance between the neighbor point and the current point.

In some example embodiments, at block 604, a nearest neighbor candidate list of the current point is updated based on the at least one neighbor list, and the conversion is performed based on the nearest neighbor candidate list. By way of example, the nearest neighbor candidate list may comprise the list 1.

In some example embodiments, at least one neighbor list comprises neighbor points from different directions.

In some example embodiments, a neighbor point in the at least one neighbor list has a nearest distance to the current point.

In some example embodiments, a distance between the neighbor point and the current point is determined by using one of: a Euclidean distance, a Manhattan distance, a Chebyshev distance, or any other suitable distance metric.

In some example embodiments, the method 600 further comprises for a neighbor point of the current point, determining a vector direction for the current point.

In some example embodiments, the vector direction may be determined based on a difference between a coordinate of the neighbor point and a coordinate of the current point.

In some example embodiments, the method 600 further comprises clustering a plurality of points into at least one cluster based on respective vector directions of the plurality of points.

In some example embodiments, vector directions of neighbor points in a cluster are within a predetermined direction range. As used herein, points with a same predetermined direction range may be referred to as points in a same direction.

In some example embodiments, a cluster comprises a neighbor point within a predetermined direction range with a nearest distance to the current point.

In some example embodiments, the at least one neighbor list may be determined by using nearest neighbor points in at least one cluster.

In some example embodiments, the method 600 further comprises: determining a nearest neighbor candidate list containing nearest neighbor points from a plurality of candidate search points; and removing points in the nearest neighbor candidate list from the at least one neighbor list. For example, the nearest candidate list may be determined from all candidate search points. The nearest candidate list may be the list 1.

In some example embodiments, the method 600 further comprises: sorting the set of neighbor points in the at least one neighbor list based on respective distances between the set of neighbor points and the current point.

In some example embodiments, the method 600 further comprises: updating a nearest neighbor candidate list based on the sorted set of neighbor points, a higher sorted neighbor point being assigned with a higher priority.

In some example embodiments, the set of neighbor points is from a plurality of candidate search points. For example, the set of neighbor points may be from all candidate search points.

In some example embodiments, the set of neighbor points is dropped out during an update of another point list.

In some example embodiments, a distance between a point and the current point is determined by using one of: a Euclidean distance, a Manhattan distance, a Chebyshev distance, or any other suitable distance metric.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, at least one neighbor list comprising a set of neighbor points of a current point of a current frame of the point cloud sequence is determined based on geometry information of the set of neighbor points. The bitstream is generated based on the at least one neighbor list.

According to embodiments of the present disclosure, a method for storing a bitstream of a point cloud sequence is proposed. In the method, at least one neighbor list comprising a set of neighbor points of a current point of a current frame of the point cloud sequence is determined based on geometry information of the set of neighbor points. The bitstream is generated based on the at least one neighbor list. The bitstream is stored in a non-transitory computer-readable recording medium.

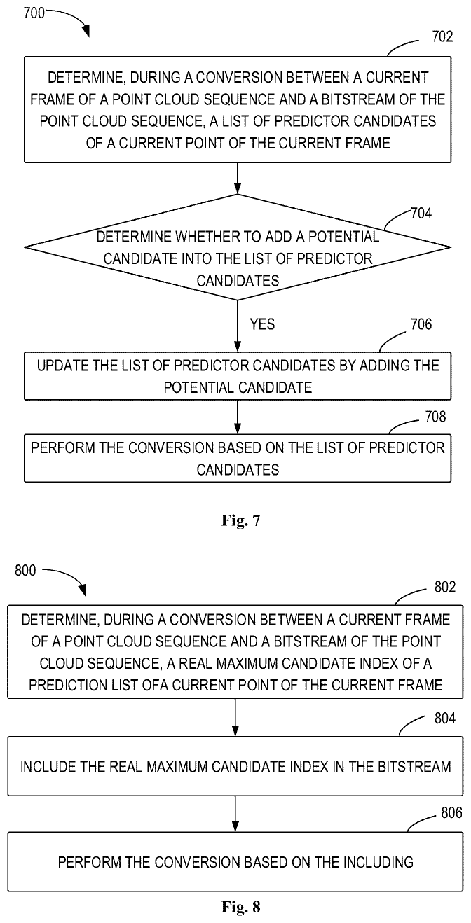

FIG. 7 illustrates a flowchart of method 700 for point cloud coding in accordance with some embodiments of the present disclosure. The method 700 may be implemented during a conversion between a current frame of a point cloud sequence and a bitstream of the point cloud sequence. As shown in FIG. 7, the method 700 starts at block 702, where a list of predictor candidates of a current point of the current frame is determined. At block 704, whether to add a potential candidate into the list of predictor candidates is determined. If it is determined to add the potential candidate at block 704, the list of predictor candidates is updated by adding the potential candidate at block 706; and performing the conversion based on the list of predictor candidates. By making a determination before adding a potential candidate into the candidate list, the prediction of the current point is improved. In this way, the coding efficiency can be improved. As used herein, such candidate list updating process may be referred to as a pruning process.

At block 708, a conversion between the current frame of the point cloud sequence and the bitstream of the point cloud sequence is performed based on the list of predictor candidates. In some embodiments the conversion may include encoding the current frame into the bitstream. Alternatively, or in addition, the conversion may include decoding the current frame from the bitstream.

In some example embodiments, a predictor candidate comprises an attribute prediction or a geometry prediction.

In some example embodiments, at block 704, whether to add the potential candidate into the list of predictor candidates may be determined based on a comparison between the potential candidate and at least one candidate in the list of predictor candidates.

In some example embodiments, at block 704, if the potential candidate is identical to or similar to a candidate in the list of predictor candidates, it is determined not to add the potential candidate into the list of predictor candidates.

In some example embodiments, a predictor candidate comprises a single dimension attribute prediction. At block 704, if a comparison of a single dimension between the potential candidate and a candidate in the list of predictor candidates indicates that the potential candidate is identical to or similar to the candidate in the list of predictor candidates, it is determined not to add the potential candidate into the list of predictor candidates.

In some example embodiments, a predictor candidate comprises a single dimension attribute prediction. At block 704, if a comparison of a single dimension among a plurality of candidates indicates that attribute values of the plurality of candidates are equal, it is determined to add one of the plurality of candidates into the list of predictor candidates.

By way of example, a single dimension attribute comprises a reflection.

In some example embodiments, a predictor candidate comprises a multiple dimensions attribute prediction. At block 704, if a comparison of at least one dimension of multiple dimensions between the potential candidate and a candidate in the list of predictor candidates indicates that the potential candidate is identical to or similar to the candidate in the list of predictor candidates, it is determined not to add the potential candidate into the list of predictor candidates.

In some example embodiments, a predictor candidate comprises a multiple dimensions attribute prediction. At block 704, if a comparison of multiple dimensions among a plurality of candidates indicates that attribute values of the plurality of candidates are equal, it is determined to add one of the plurality of candidates into the list of predictor candidates.

By way of example, a multiple dimensions attribute comprises a color.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a list of predictor candidates of the current point is determined. If it is determined to add a potential candidate into the list of predictor candidates. the list of predictor candidates is updated by adding the potential candidate. The bitstream is generated based on the list of predictor candidates.

According to embodiments of the present disclosure, a method for storing a bitstream of a point cloud sequence is proposed. In the method, a list of predictor candidates of the current point is determined. If it is determined to add a potential candidate into the list of predictor candidates. the list of predictor candidates is updated by adding the potential candidate. The bitstream is generated based on the list of predictor candidates. The bitstream is stored in a non-transitory computer-readable recording medium.

FIG. 8 illustrates a flowchart of method 800 for point cloud coding in accordance with some embodiments of the present disclosure. The method 800 may be implemented during a conversion between a current frame of a point cloud sequence and a bitstream of the point cloud sequence. As shown in FIG. 8, the method 800 starts at block 802, where a real maximum candidate index of a prediction list of a current point of the current frame is determined. At block 804, the real maximum candidate index is included in the bitstream. That is, the real maximum candidate index is signaled. By including the real maximum candidate index in the bitstream, the coding efficiency can be improved.

At block 806, a conversion between the current frame of the point cloud sequence and the bitstream of the point cloud sequence is performed based on the including. In some embodiments the conversion may include encoding the current frame into the bitstream. Alternatively, or in addition, the conversion may include decoding the current frame from the bitstream.

In some example embodiments, at block 802, the real maximum candidate index may be determined based on at least one of: a number of points in the prediction list, a maximum number of single point predictors used for direct prediction, or an indicator of whether a point predictor set average being a direct prediction mode. The prediction list may be the list 1.

In some example embodiments, the real maximum candidate index is determined by using the following: maxCanIdx=min (N, pred_direct_max_idx)+!pred_direct_avg_disabled_flag, wherein maxCanIdx represents the real maximum candidate index, N represents the number of points in the prediction list, pred_direct_max_idx represents the maximum number of single point predictors used for direct prediction, pred_direct_avg_disabled_flag represents the indicator of whether a point predictor set average being a direct prediction mode, and min( ) represents a function to obtain a minimum value. As used herein, the parameter pred_direct_max_idx may also be referred to as parameter pred_direct_max_idx_plus1. The parameter pred_direct_avg_disabled_flag may also be referred to as parameter pred_direct_avg_disabled.

In some example embodiments, at block 802, if predictor candidates in the prediction list are created with a pruning process, the real maximum candidate index may be determined by subtracting a predefined value from a number of predictor candidates. By way of example, the predefined value may comprise 1 or other suitable integer.

In some example embodiments, at block 804, a bit length of a fixed-length coding may be determined based on the real maximum candidate index. The real maximum candidate index may be included in the bitstream by using the fixed-length coding.

Alternatively, or in addition, in some example embodiments, at block 804, a minimum value of a truncated unary coding may be determined based on the real maximum candidate index. The real maximum candidate index may be included in the bitstream by using the truncated unary coding.

In some example embodiments, at block 804, the real maximum candidate index may be included with other signals in the bitstream. By way of example, the other signals comprises attribute residuals. That is, the predictor index may be signaled joint with other signals such as attribute residuals.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a real maximum candidate index of a prediction list of a current point of a current frame of the point cloud sequence is determined. The real maximum candidate index is included in the bitstream. The bitstream is generated based on the including.

According to embodiments of the present disclosure, a method for storing a bitstream of a point cloud sequence is proposed. In the method, a real maximum candidate index of a prediction list of a current point of a current frame of the point cloud sequence is determined. The real maximum candidate index is included in the bitstream. The bitstream is generated based on the including. The bitstream is stored in a non-transitory computer-readable recording medium.

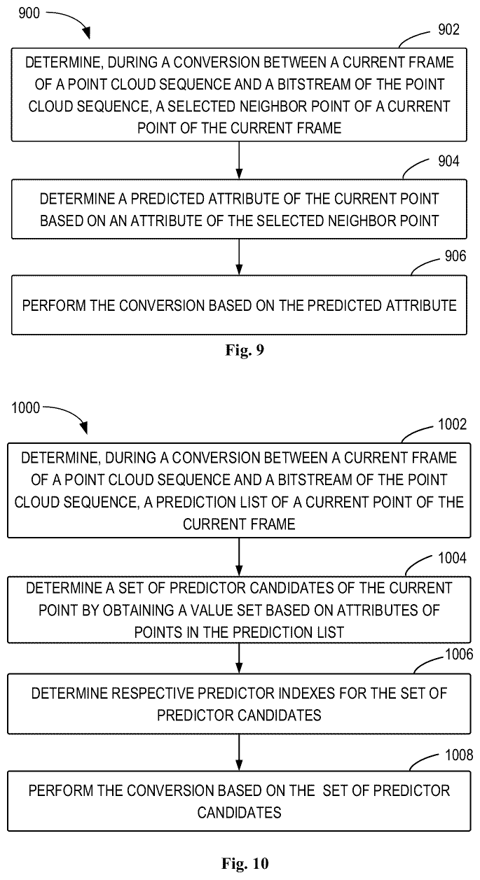

FIG. 9 illustrates a flowchart of method 900 for point cloud coding in accordance with some embodiments of the present disclosure. The method 900 may be implemented during a conversion between a current frame of a point cloud sequence and a bitstream of the point cloud sequence. As shown in FIG. 9, the method 900 starts at block 902, where a selected neighbor point of a current point of the current frame is determined. At block 904, a predicted attribute of the current point based on an attribute of the selected neighbor point is determined. By determining a predicted attribute of the current point based on an attribute of a selected neighbor point, the attribute prediction of the current point can be improved. In this way, the coding efficiency can be improved.

At block 906, a conversion between the current frame of the point cloud sequence and the bitstream of the point cloud sequence is performed based on the predicted attribute. In some embodiments the conversion may include encoding the current frame into the bitstream. Alternatively, or in addition, the conversion may include decoding the current frame from the bitstream.

In some example embodiments, at block 902, the selected neighbor point may be determined by searching a set of candidate search points. In some example embodiments, a candidate search point with a minimum distance may be determined to the current point as the selected neighbor point.

In some example embodiments, the set of candidate search points may be searched based on one of the following: a Euclidean distance, a Manhattan distance, a Chebyshev distance, or any other suitable distance metric.

In some example embodiments, at block 902, the selected neighbor point may be selected from a set of points in the bitstream. In other words, the selected neighbor point may be selected from a set of points that have been signaled.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a selected neighbor point of a current point of a current frame of the point cloud sequence is determined. A predicted attribute of the current point is determined based on an attribute of the selected neighbor point. The bitstream is generated based on the predicted attribute.

According to embodiments of the present disclosure, a method for storing a bitstream of a point cloud sequence is proposed. In the method, a selected neighbor point of a current point of a current frame of the point cloud sequence is determined. A predicted attribute of the current point is determined based on an attribute of the selected neighbor point. The bitstream is generated based on the predicted attribute. The bitstream is stored in a non-transitory computer-readable recording medium.

FIG. 10 illustrates a flowchart of method 1000 for point cloud coding in accordance with some embodiments of the present disclosure. The method 1000 may be implemented during a conversion between a current frame of a point cloud sequence and a bitstream of the point cloud sequence. As shown in FIG. 10, the method 1000 starts at block 1002, where a prediction list of a current point of the current frame is determined. At block 1004, a set of predictor candidates of the current point is determined by obtaining a value set based on attributes of points in the prediction list. At block 1006, respective predictor indexes for the set of predictor candidates are determined. For example, the value set may be set to different predictor indexes. By determining the predictor candidates by obtaining the value set based on attributes of points, the attribute prediction of the current point can be improved. In this way, the coding efficiency can be improved.

At block 1008, a conversion between the current frame of the point cloud sequence and the bitstream of the point cloud sequence is performed based on the set of predictor candidates. In some embodiments the conversion may include encoding the current frame into the bitstream. Alternatively, or in addition, the conversion may include decoding the current frame from the bitstream.

In some example embodiments, at block 1004, outputs of a metric may be obtained based on the attributes of points in the prediction list as the value set. The value set may be determined as the set of predictor candidates. In some example embodiments, the metric comprises a median metric. In other words, the value set may be the output of a function such as the median function of the attributes of the point in a prediction list. The prediction list may comprise the list 1.

In some example embodiments, a value in the value set is used as a predictor candidate of the current point.

In some example embodiments, a predictor index of the current point refers to a value in the value set. In some example embodiments, the predictor index is a non-negative integer.

In some example embodiments, the method 1000 further comprises: if predictor candidates of the current point created with a pruning process, determining a real maximum candidate index by subtracting an integer from a number of the predictor candidates. By way of example, the integer comprises 1.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a prediction list of a current point of a current frame of the point cloud sequence is determined. A set of predictor candidates of the current point is determined by obtaining a value set based on attributes of points in the prediction list. Respective predictor indexes for the set of predictor candidates are determined. The bitstream is generated based on the set of predictor candidates.

According to embodiments of the present disclosure, a method for storing a bitstream of a point cloud sequence is proposed. In the method, a prediction list of a current point of a current frame of the point cloud sequence is determined. A set of predictor candidates of the current point is determined by obtaining a value set based on attributes of points in the prediction list. Respective predictor indexes for the set of predictor candidates are determined. The bitstream is generated based on the set of predictor candidates. The bitstream is stored in a non-transitory computer-readable recording medium.

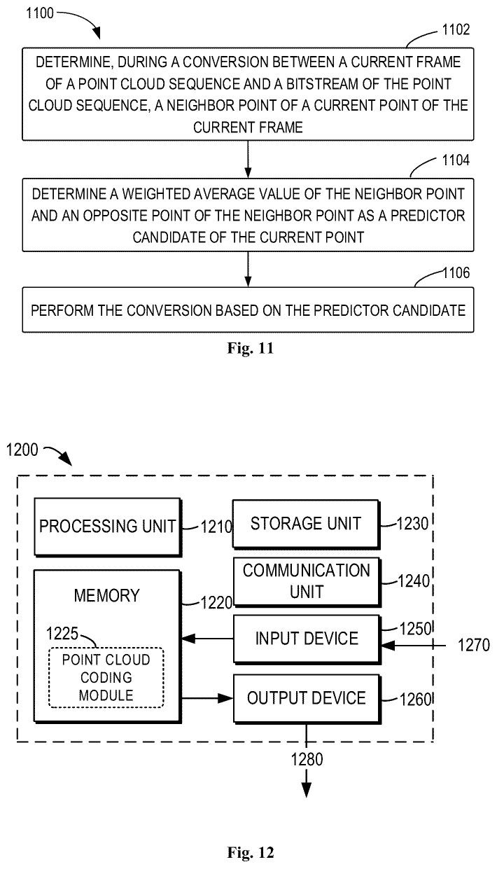

FIG. 11 illustrates a flowchart of method 1100 for point cloud coding in accordance with some embodiments of the present disclosure. The method 1100 may be implemented during a conversion between a current frame of a point cloud sequence and a bitstream of the point cloud sequence. As shown in FIG. 11, the method 1100 starts at block 1102, where a neighbor point of a current point of the current frame is determined. At block 1104, a weighted average value of the neighbor point and an opposite point of the neighbor point is determined as a predictor candidate of the current point. The opposite point is in a direction range opposite to a direction range of the neighbor point. As used herein, the opposite point in the opposite direction range may be referred to as a strict opposite point. By determining the weighted average value as a predictor candidate of the current point, the coding efficiency can be improved.

At block 1106, a conversion between the current frame of the point cloud sequence and the bitstream of the point cloud sequence is performed based on the predictor candidate. In some embodiments the conversion may include encoding the current frame into the bitstream. Alternatively, or in addition, the conversion may include decoding the current frame from the bitstream.

In some example embodiments, the method 1100 further comprises: determining a predictor index for the predictor candidate. The predictor index is different from a further predictor index of a further predictor candidate of the current point.

In some example embodiments, the neighbor point comprises a nearest neighbor point of the current point.

In some example embodiments, at block 1104, a first weight of the neighbor point may be determined based on a first distance between the neighbor point and the current point. A second weight of the opposite point may be determined based on a second distance between the opposite point and the current point. The weighted average value may be determined based on the first and second weights.

In some example embodiments, the first and second distances are determined by using one of the following: a Euclidean distance, a Manhattan distance, or a Chebyshev distance.

In some example embodiments, the Euclidean distance between a first point (x₁, y₁, z₁) and a second point (x₂, y₂, z₂) is determined by using the following:

$$d = \sqrt{{a ( {x}_{1} - {x}_{2} )}^{2} + {b ( {y}_{1} - {y}_{2} )}^{2} + c {( {z}_{1} - {z}_{2} )}^{2}} ,$$

where a, b and c are factors representing importance of different dimensions.

In some example embodiments, the Manhattan distance between a first point (x₁, y₁, z₁) and a second point (x₂, y₂, z₂) is determined by using the following:

$$d = a \vert {x}_{1} - {x}_{2} \vert + b \vert {y}_{1} - {y}_{2} \vert + c \vert {z}_{1} - {z}_{2} \vert ,$$

where a, b and c are factors representing importance of different dimensions.

In some example embodiments, the Chebyshev distance between a first point (x₁, y₁, z₁) and a second point (x₂, y₂, z₂) is determined by using the following:

$$d = max ( a \vert {x}_{1} - {x}_{2} \vert , b \vert {y}_{1} - {y}_{2} \vert , c \vert {z}_{1} - {z}_{2} \vert ) ,$$

where a, b and c are factors representing importance of different dimensions, and max( ) represents a metric that obtain a maximum of three values.

In some example embodiments, the weighted average value is used as a predictor of the current point.

In some example embodiments, a predictor index of the current point refers to the weighted average value. In some example embodiments, the predictor index is a non-negative integer.

In some example embodiments, if predictor candidates of the current point are created with a pruning process, the predictor index is a positive integer.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a neighbor point of a current point of a current frame of the point cloud sequence is determined. A weighted average value of the neighbor point and an opposite point of the neighbor point is determined as a predictor candidate of the current point. The opposite point is in a direction range opposite to a direction range of the neighbor point. The bitstream is generated based on the predictor candidate.

According to embodiments of the present disclosure, a method for storing a bitstream of a point cloud sequence is proposed. In the method, a neighbor point of a current point of a current frame of the point cloud sequence is determined. A weighted average value of the neighbor point and an opposite point of the neighbor point is determined as a predictor candidate of the current point. The opposite point is in a direction range opposite to a direction range of the neighbor point. The bitstream is generated based on the predictor candidate. The bitstream is stored in a non-transitory computer-readable recording medium.

It is to be understood that the above method 600, method 700, method 800, method 900, method 1000 and/or method 1100 may be used in combination or separately. Any suitable combination of these methods may be applied. Scope of the present disclosure is not limited in this regard.

By using these methods 600, 700, 800, 900, 1000 and 1100 separately or in combination, the coding effectiveness and coding efficiency of the point cloud coding can be improved.

Implementations of the present disclosure can be described in view of the following clauses, the features of which can be combined in any reasonable manner.

Clause 1. A method for point cloud coding, comprising: determining, during a conversion between a current frame of a point cloud sequence and a bitstream of the point cloud sequence, at least one neighbor list comprising a set of neighbor points of a current point of the current frame based on geometry information of the set of neighbor points; and performing the conversion based on the at least one neighbor list.

Clause 2. The method of clause 1, wherein the geometry information for a neighbor point in the set of neighbor points comprises a distance between the neighbor point and the current point.

Clause 3. The method of clause 1 or clause 2, wherein performing the conversion based on the at least one neighbor list comprises: updating a nearest neighbor candidate list of the current point based on the at least one neighbor list; and performing the conversion based on the nearest neighbor candidate list.

Clause 4. The method of any of clauses 1-3, wherein at least one neighbor list comprises neighbor points from different directions.

Clause 5. The method of any of clauses 1-4, wherein a neighbor point in the at least one neighbor list has a nearest distance to the current point.

Clause 6. The method of clause 5, wherein a distance between the neighbor point and the current point is determined by using one of: a Euclidean distance, a Manhattan distance, or a Chebyshev distance.

Clause 7. The method of any of clauses 1-6, further comprising: for a neighbor point of the current point, determining a vector direction for the current point.

Clause 8. The method of clause 7, wherein determining the vector direction comprises: determining the vector direction based on a difference between a coordinate of the neighbor point and a coordinate of the current point.

Clause 9. The method of any of clauses 1-8, further comprising: clustering a plurality of points into at least one cluster based on respective vector directions of the plurality of points.

Clause 10. The method of clause 9, wherein vector directions of neighbor points in a cluster are within a predetermined direction range.

Clause 11. The method of clause 9, wherein a cluster comprises a neighbor point within a predetermined direction range with a nearest distance to the current point.

Clause 12. The method of any of clauses 9-11, wherein determining the at least one neighbor list comprises: determining the at least one neighbor list by using nearest neighbor points in at least one cluster.

Clause 13. The method of any of clauses 1-12, further comprising: determining a nearest neighbor candidate list containing nearest neighbor points from a plurality of candidate search points; and removing points in the nearest neighbor candidate list from the at least one neighbor list.

Clause 14. The method of any of clauses 1-13, further comprising: sorting the set of neighbor points in the at least one neighbor list based on respective distances between the set of neighbor points and the current point.

Clause 15. The method of clause 14, further comprising: updating a nearest neighbor candidate list based on the sorted set of neighbor points, a higher sorted neighbor point being assigned with a higher priority.

Clause 16. The method of any of clauses 1-15, wherein the set of neighbor points is from a plurality of candidate search points.

Clause 17. The method of any of clauses 1-15, wherein the set of neighbor points is dropped out during an update of another point list.

Clause 18. The method of any of clauses 1-17, wherein a distance between a point and the current point is determined by using one of: a Euclidean distance, a Manhattan distance, or a Chebyshev distance.

Clause 19. A method for point cloud coding, comprising: determining, during a conversion between a current frame of a point cloud sequence and a bitstream of the point cloud sequence, a list of predictor candidates of a current point of the current frame; determining whether to add a potential candidate into the list of predictor candidates; in accordance with a determination to add the potential candidate, updating the list of predictor candidates by adding the potential candidate; and performing the conversion based on the list of predictor candidates.

Clause 20. The method of clause 19, wherein a predictor candidate comprises an attribute prediction or a geometry prediction.

Clause 21. The method of clause 19 or clause 20, wherein determining whether to add a potential candidate into the list of predictor candidates: determining whether to add the potential candidate into the list of predictor candidates based on a comparison between the potential candidate and at least one candidate in the list of predictor candidates.

Clause 22. The method of any of clauses 19-21, wherein determining whether to add a potential candidate into the list of predictor candidates: if the potential candidate is identical to or similar to a candidate in the list of predictor candidates, determining not to add the potential candidate into the list of predictor candidates.

Clause 23. The method of any of clauses 19-22, wherein a predictor candidate comprises a single dimension attribute prediction, and wherein determining whether to add a potential candidate into the list of predictor candidates: if a comparison of a single dimension between the potential candidate and a candidate in the list of predictor candidates indicates that the potential candidate is identical to or similar to the candidate in the list of predictor candidates, determining not to add the potential candidate into the list of predictor candidates.

Clause 24. The method of any of clauses 19-22, wherein a predictor candidate comprises a single dimension attribute prediction, and wherein determining whether to add a potential candidate into the list of predictor candidates: if a comparison of a single dimension among a plurality of candidates indicates that attribute values of the plurality of candidates are equal, determining to add one of the plurality of candidates into the list of predictor candidates.

Clause 25. The method of clause 23 or clause 24, wherein a single dimension attribute comprises a reflection.

Clause 26. The method of any of clauses 19-22, wherein a predictor candidate comprises a multiple dimensions attribute prediction, and wherein determining whether to add a potential candidate into the list of predictor candidates: if a comparison of at least one dimension of multiple dimensions between the potential candidate and a candidate in the list of predictor candidates indicates that the potential candidate is identical to or similar to the candidate in the list of predictor candidates, determining not to add the potential candidate into the list of predictor candidates.

Clause 27. The method of any of clauses 19-22, wherein a predictor candidate comprises a multiple dimensions attribute prediction, and wherein determining whether to add a potential candidate into the list of predictor candidates: if a comparison of multiple dimensions among a plurality of candidates indicates that attribute values of the plurality of candidates are equal, determining to add one of the plurality of candidates into the list of predictor candidates.

Clause 28. The method of clause 26 or clause 27, wherein a multiple dimensions attribute comprises a color.

Clause 29. A method for point cloud coding, comprising: determining, during a conversion between a current frame of a point cloud sequence and a bitstream of the point cloud sequence, a real maximum candidate index of a prediction list of a current point of the current frame; including the real maximum candidate index in the bitstream; and performing the conversion based on the including.

Clause 30. The method of clause 29, wherein determining the real maximum candidate index comprises: determining the real maximum candidate index based on at least one of: a number of points in the prediction list, a maximum number of single point predictors used for direct prediction, or an indicator of whether a point predictor set average being a direct prediction mode.

Clause 31. The method of clause 30, wherein the real maximum candidate index is determined by using the following: maxCanIdx=min (N, pred_direct_max_idx)+!pred_direct_avg_disabled_flag, wherein maxCanIdx represents the real maximum candidate index, N represents the number of points in the prediction list, pred_direct_max_idx represents the maximum number of single point predictors used for direct prediction, pred_direct_avg_disabled_flag represents the indicator of whether a point predictor set average being a direct prediction mode, and min( ) represents a function to obtain a minimum value.

Clause 32. The method of clause 29, wherein determining the real maximum candidate index comprises: if predictor candidates in the prediction list are created with a pruning process, determining the real maximum candidate index by subtracting a predefined value from a number of predictor candidates.

Clause 33. The method of clause 32, wherein the predefined value comprises 1.

Clause 34. The method of any of clauses 29-33, wherein including the real maximum candidate index in the bitstream comprises: determining a bit length of a fixed-length coding based on the real maximum candidate index; and including the real maximum candidate index in the bitstream by using the fixed-length coding.

Clause 35. The method of any of clauses 29-33, wherein including the real maximum candidate index in the bitstream comprises: determining a minimum value of a truncated unary coding based on the real maximum candidate index; and including the real maximum candidate index in the bitstream by using the truncated unary coding.

Clause 36. The method of any of clauses 29-35, wherein including the real maximum candidate index in the bitstream comprises: including the real maximum candidate index with other signals in the bitstream.

Clause 37. The method of clause 36, wherein the other signals comprises attribute residuals.

Clause 38. A method for point cloud coding, comprising: determining, during a conversion between a current frame of a point cloud sequence and a bitstream of the point cloud sequence, a selected neighbor point of a current point of the current frame; determining a predicted attribute of the current point based on an attribute of the selected neighbor point; and performing the conversion based on the predicted attribute.

Clause 39. The method of clause 38, wherein determining the selected neighbor point comprises: determining the selected neighbor point by searching a set of candidate search points.

Clause 40. The method of clause 39, wherein determining the selected neighbor point by searching a set of candidate search points comprises: determining a candidate search point with a minimum distance to the current point as the selected neighbor point.

Clause 41. The method of clause 39 or clause 40, wherein searching the set of candidate search points is based on one of the following: a Euclidean distance, a Manhattan distance, or a Chebyshev distance.

Clause 42. The method of clause 38, wherein determining the selected neighbor point comprises: selecting the selected neighbor point from a set of points in the bitstream.

Clause 43. A method for point cloud coding, comprising: determining, during a conversion between a current frame of a point cloud sequence and a bitstream of the point cloud sequence, a prediction list of a current point of the current frame; determining a set of predictor candidates of the current point by obtaining a value set based on attributes of points in the prediction list; determining respective predictor indexes for the set of predictor candidates; and performing the conversion based on the set of predictor candidates.

Clause 44. The method of clause 43, wherein determining the set of predictor candidates of the current point by obtaining the value set based on attributes of points in the prediction list comprises: obtaining outputs of a metric based on the attributes of points in the prediction list as the value set; and determining the value set as the set of predictor candidates.

Clause 45. The method of clause 44, wherein the metric comprises a median metric.

Clause 46. The method of any of clauses 43-45, wherein a value in the value set is used as a predictor candidate of the current point.

Clause 47. The method of any of clauses 43-46, wherein a predictor index of the current point refers to a value in the value set.

Clause 48. The method of clause 47, wherein the predictor index is a non-negative integer.

Clause 49. The method of any of clauses 43-48, further comprising: if predictor candidates of the current point created with a pruning process, determining a real maximum candidate index by subtracting an integer from a number of the predictor candidates.

Clause 50. The method of clause 49, wherein the integer comprises 1.

Clause 51. A method for point cloud coding, comprising: determining, during a conversion between a current frame of a point cloud sequence and a bitstream of the point cloud sequence, a neighbor point of a current point of the current frame; determining a weighted average value of the neighbor point and an opposite point of the neighbor point as a predictor candidate of the current point, the opposite point being in a direction range opposite to a direction range of the neighbor point; and performing the conversion based on the predictor candidate.

Clause 52. The method of clause 51, further comprising: determining a predictor index for the predictor candidate, the predictor index being different from a further predictor index of a further predictor candidate of the current point.

Clause 53. The method of clause 51 or clause 52, wherein the neighbor point comprises a nearest neighbor point of the current point.

Clause 54. The method of any of clauses 51-53, wherein determining a weighted average value of the neighbor point and an opposite point comprises: determining a first weight of the neighbor point based on a first distance between the neighbor point and the current point; determining a second weight of the opposite point based on a second distance between the opposite point and the current point; and determining the weighted average value based on the first and second weights.

Clause 55. The method of clause 54, wherein the first and second distances are determined by using one of the following: a Euclidean distance, a Manhattan distance, or a Chebyshev distance.

Clause 56. The method of clause 55, wherein the the Euclidean distance between a first point (x₁, y₁, z₁) and a second point (x₂, y₂, z₂) is determined by using the following:

$$d = \sqrt{{a ( {x}_{1} - {x}_{2} )}^{2} + {b ( {y}_{1} - {y}_{2} )}^{2} + {c ( {z}_{1} - {z}_{2} )}^{2}} ,$$

where a, b and c are factors representing importance of different dimensions.

Clause 57. The method of clause 55, wherein the Manhattan distance between a first point (x₁, y₁, z₁) and a second point (x₂, y₂, z₂) is determined by using the following:

$$d = a \vert {x}_{1} - {x}_{2} \vert + b \vert {y}_{1} - {y}_{2} \vert + c \vert {z}_{1} - {z}_{2} \vert ,$$

where a, b and c are factors representing importance of different dimensions.

Clause 58. The method of clause 55, wherein the Chebyshev distance between a first point (x₁, y₁, z₁) and a second point (x₂, y₂, z₂) is determined by using the following:

$$d = max ( a \vert {x}_{1} - {x}_{2} \vert , b \vert {y}_{1} - {y}_{2} \vert , c \vert {z}_{1} - {z}_{2} \vert ) ,$$

where a, b and c are factors representing importance of different dimensions, and max( ) represents a metric that obtain a maximum of three values.

Clause 59. The method of any of clauses 51-58, wherein the weighted average value is used as a predictor of the current point.

Clause 60. The method of any of clauses 51-59, wherein a predictor index of the current point refers to the weighted average value.

Clause 61. The method of clause 60, wherein the predictor index is a non-negative integer.

Clause 62. The method of clause 60, wherein if predictor candidates of the current point are created with a pruning process, the predictor index is a positive integer.

Clause 63. The method of any of clauses 1-62, wherein the conversion includes encoding the current frame into the bitstream.

Clause 64. The method of any of clauses 1-62, wherein the conversion includes decoding the current frame from the bitstream.

Clause 65. An apparatus for processing video data comprising a processor and a non-transitory memory with instructions thereon, wherein the instructions upon execution by the processor, cause the processor to perform a method in accordance with any of clauses 1-64.

Clause 66. A non-transitory computer-readable storage medium storing instructions that cause a processor to perform a method in accordance with any of clauses 1-64.

Clause 67. A non-transitory computer-readable recording medium storing a bitstream of a point cloud sequence which is generated by a method performed by a point cloud sequence processing apparatus, wherein the method comprises: determining at least one neighbor list comprising a set of neighbor points of a current point of a current frame of the point cloud sequence based on geometry information of the set of neighbor points; and generating the bitstream based on the at least one neighbor list.

Clause 68. A method for storing a bitstream of a point cloud sequence, comprising: determining at least one neighbor list comprising a set of neighbor points of a current point of a current frame of the point cloud sequence based on geometry information of the set of neighbor points; generating the bitstream based on the at least one neighbor list; and storing the bitstream in a non-transitory computer-readable recording medium.

Clause 69. A non-transitory computer-readable recording medium storing a bitstream of a point cloud sequence which is generated by a method performed by a point cloud sequence processing apparatus, wherein the method comprises: determining a list of predictor candidates of a current point of a current frame of the point cloud sequence; determining whether to add a potential candidate into the list of predictor candidates; in accordance with a determination to add the potential candidate, updating the list of predictor candidates by adding the potential candidate; and generating the bitstream based on the list of predictor candidates.

Clause 70. A method for storing a bitstream of a point cloud sequence, comprising: determining a list of predictor candidates of a current point of a current frame of the point cloud sequence; determining whether to add a potential candidate into the list of predictor candidates; in accordance with a determination to add the potential candidate, updating the list of predictor candidates by adding the potential candidate; generating the bitstream based on the list of predictor candidates; and storing the bitstream in a non-transitory computer-readable recording medium.

Clause 71. A non-transitory computer-readable recording medium storing a bitstream of a point cloud sequence which is generated by a method performed by a point cloud sequence processing apparatus, wherein the method comprises: determining a real maximum candidate index of a prediction list of a current point of a current frame of the point cloud sequence; including the real maximum candidate index in the bitstream; and generating the bitstream based on the including.

Clause 72. A method for storing a bitstream of a point cloud sequence, comprising: determining a real maximum candidate index of a prediction list of a current point of a current frame of the point cloud sequence; including the real maximum candidate index in the bitstream; generating the bitstream based on the determining a real maximum candidate index of a prediction list of a current point of a current frame of the point cloud sequence; including the real maximum candidate index in the bitstream; and generating the bitstream based on the including; and storing the bitstream in a non-transitory computer-readable recording medium.

Clause 73. A non-transitory computer-readable recording medium storing a bitstream of a point cloud sequence which is generated by a method performed by a point cloud sequence processing apparatus, wherein the method comprises: determining a selected neighbor point of a current point of a current frame of the point cloud sequence; determining a predicted attribute of the current point based on an attribute of the selected neighbor point; and generating the bitstream based on the predicted attribute.

Clause 74. A method for storing a bitstream of a point cloud sequence, comprising: determining a selected neighbor point of a current point of a current frame of the point cloud sequence; determining a predicted attribute of the current point based on an attribute of the selected neighbor point; generating the bitstream based on the predicted attribute; and storing the bitstream in a non-transitory computer-readable recording medium.

Clause 75. A non-transitory computer-readable recording medium storing a bitstream of a point cloud sequence which is generated by a method performed by a point cloud sequence processing apparatus, wherein the method comprises: determining a prediction list of a current frame of a point cloud sequence; determining a set of predictor candidates of the current point by obtaining a value set based on attributes of points in the prediction list; determining respective predictor indexes for the set of predictor candidates; and generating the bitstream based on the set of predictor candidates.

Clause 76. A method for storing a bitstream of a point cloud sequence, comprising: determining a prediction list of a current frame of a point cloud sequence; determining a set of predictor candidates of the current point by obtaining a value set based on attributes of points in the prediction list; determining respective predictor indexes for the set of predictor candidates; generating the bitstream based on the set of predictor candidates; and storing the bitstream in a non-transitory computer-readable recording medium.

Clause 77. A non-transitory computer-readable recording medium storing a bitstream of a point cloud sequence which is generated by a method performed by a point cloud sequence processing apparatus, wherein the method comprises: determining, a neighbor point of a current point of a current frame of the point cloud sequence; determining a weighted average value of the neighbor point and an opposite point of the neighbor point as a predictor candidate of the current point, the opposite point being in a direction range opposite to a direction range of the neighbor point; and generating the bitstream based on the predictor candidate.

Clause 78. A method for storing a bitstream of a point cloud sequence, comprising: determining, a neighbor point of a current point of a current frame of the point cloud sequence; determining a weighted average value of the neighbor point and an opposite point of the neighbor point as a predictor candidate of the current point, the opposite point being in a direction range opposite to a direction range of the neighbor point; generating the bitstream based on the predictor candidate; and storing the bitstream in a non-transitory computer-readable recording medium.

### Example Device

FIG. 12 illustrates a block diagram of a computing device 1200 in which various embodiments of the present disclosure can be implemented. The computing device 1200 may be implemented as or included in the source device 110 (or the GPCC encoder 116 or 200) or the destination device 120 (or the GPCC decoder 126 or 300).

It would be appreciated that the computing device 1200 shown in FIG. 12 is merely for purpose of illustration, without suggesting any limitation to the functions and scopes of the embodiments of the present disclosure in any manner.

As shown in FIG. 12, the computing device 1200 includes a general-purpose computing device 1200. The computing device 1200 may at least comprise one or more processors or processing units 1210, a memory 1220, a storage unit 1230, one or more communication units 1240, one or more input devices 1250, and one or more output devices 1260.

In some embodiments, the computing device 1200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1200 can support any type of interface to a user (such as “wearable” circuitry and the like).

The processing unit 1210 may be a physical or virtual processor and can implement various processes based on programs stored in the memory 1220. In a multi-processor system, multiple processing units execute computer executable instructions in parallel so as to improve the parallel processing capability of the computing device 1200. The processing unit 1210 may also be referred to as a central processing unit (CPU), a microprocessor, a controller or a microcontroller.

The computing device 1200 typically includes various computer storage medium. Such medium can be any medium accessible by the computing device 1200, including, but not limited to, volatile and non-volatile medium, or detachable and non-detachable medium. The memory 1220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1230 may be any detachable or non-detachable medium and may include a machine-readable medium such as a memory, flash memory drive, magnetic disk or another other media, which can be used for storing information and/or data and can be accessed in the computing device 1200.

The computing device 1200 may further include additional detachable/non-detachable, volatile/non-volatile memory medium. Although not shown in FIG. 12, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1240 communicates with a further computing device via the communication medium. In addition, the functions of the components in the computing device 1200 can be implemented by a single computing cluster or multiple computing machines that can communicate via communication connections. Therefore, the computing device 1200 can operate in a networked environment using a logical connection with one or more other servers, networked personal computers (PCs) or further general network nodes.

The input device 1250 may be one or more of a variety of input devices, such as a mouse, keyboard, tracking ball, voice-input device, and the like. The output device 1260 may be one or more of a variety of output devices, such as a display, loudspeaker, printer, and the like. By means of the communication unit 1240, the computing device 1200 can further communicate with one or more external devices (not shown) such as the storage devices and display device, with one or more devices enabling the user to interact with the computing device 1200, or any devices (such as a network card, a modem and the like) enabling the computing device 1200 to communicate with one or more other computing devices, if required. Such communication can be performed via input/output (I/O) interfaces (not shown).

In some embodiments, instead of being integrated in a single device, some or all components of the computing device 1200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1200 may be used to implement point cloud encoding/decoding in embodiments of the present disclosure. The memory 1220 may include one or more point cloud coding modules 1225 having one or more program instructions. These modules are accessible and executable by the processing unit 1210 to perform the functionalities of the various embodiments described herein.

In the example embodiments of performing point cloud encoding, the input device 1250 may receive point cloud data as an input 1270 to be encoded. The point cloud data may be processed, for example, by the point cloud coding module 1225, to generate an encoded bitstream. The encoded bitstream may be provided via the output device 1260 as an output 1280.

In the example embodiments of performing point cloud decoding, the input device 1250 may receive an encoded bitstream as the input 1270. The encoded bitstream may be processed, for example, by the point cloud coding module 1225, to generate decoded point cloud data. The decoded point cloud data may be provided via the output device 1260 as the output 1280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, during a conversion between a current frame of a point cloud sequence and a bitstream of the point cloud sequence, first information comprising at least one of: at least one neighbor list comprising a set of neighbor points of a current point of the current frame based on geometry information of the set of neighbor points, a list of predictor candidates of a current point of the current frame, a real maximum candidate index of a prediction list of a current point of the current frame, a selected neighbor point of a current point of the current frame, a prediction list of a current point of the current frame, or a neighbor point of a current point of the current frame; and
performing the conversion based on the first information.

2. The method of claim 1, wherein the geometry information for a neighbor point in the set of neighbor points comprises a distance between the neighbor point and the current point, wherein performing the conversion based on the first information comprises:
updating a nearest neighbor candidate list of the current point based on the at least one neighbor list; and
performing the conversion based on the nearest neighbor candidate list, wherein at least one neighbor list comprises neighbor points from different directions, wherein a neighbor point in the at least one neighbor list has a nearest distance to the current point, wherein a distance between the neighbor point and the current point is determined by using one of:
a Euclidean distance,
a Manhattan distance, or
a Chebyshev distance.

3. The method of claim 2, further comprising:
for a neighbor point of the current point, determining a vector direction for the current point, wherein determining the vector direction comprises:
determining the vector direction based on a difference between a coordinate of the neighbor point and a coordinate of the current point.

4. The method of claim 3, further comprising:
clustering a plurality of points into at least one cluster based on respective vector directions of the plurality of points, wherein vector directions of neighbor points in a cluster are within a predetermined direction range, wherein a cluster comprises a neighbor point within a predetermined direction range with a nearest distance to the current point, wherein determining the at least one neighbor list comprises:
determining the at least one neighbor list by using nearest neighbor points in at least one cluster.

5. The method of claim 4, further comprising at least one of:
determining a nearest neighbor candidate list containing nearest neighbor points from a plurality of candidate search points; and
removing points in the nearest neighbor candidate list from the at least one neighbor list,
sorting the set of neighbor points in the at least one neighbor list based on respective distances between the set of neighbor points and the current point, or updating a nearest neighbor candidate list based on the sorted set of neighbor points, a higher sorted neighbor point being assigned with a higher priority, wherein the set of neighbor points is from a plurality of candidate search points, wherein the set of neighbor points is dropped out during an update of another point list, wherein a distance between a point and the current point is determined by using one of:
a Euclidean distance,
a Manhattan distance, or
a Chebyshev distance.

6. The method of claim 1, further comprising:
determining a list of predictor candidates of a current point of the current frame;
determining whether to add a potential candidate into the list of predictor candidates; and
in accordance with a determination to add the potential candidate, updating the list of predictor candidates by adding the potential candidate; wherein the conversion is performed based on the list of predictor candidates.

7. The method of claim 6, wherein a predictor candidate comprises an attribute prediction or a geometry prediction, wherein determining whether to add a potential candidate into the list of predictor candidates:
determining whether to add the potential candidate into the list of predictor candidates based on a comparison between the potential candidate and at least one candidate in the list of predictor candidates, wherein determining whether to add a potential candidate into the list of predictor candidates:
if the potential candidate is identical to or similar to a candidate in the list of predictor candidates, determining not to add the potential candidate into the list of predictor candidates, wherein a predictor candidate comprises a single dimension attribute prediction, and wherein determining whether to add a potential candidate into the list of predictor candidates:
if a comparison of a single dimension between the potential candidate and a candidate in the list of predictor candidates indicates that the potential candidate is identical to or similar to the candidate in the list of predictor candidates, determining not to add the potential candidate into the list of predictor candidates, wherein a predictor candidate comprises a single dimension attribute prediction, and
wherein determining whether to add a potential candidate into the list of predictor candidates:
if a comparison of a single dimension among a plurality of candidates indicates that attribute values of the plurality of candidates are equal, determining to add one of the plurality of candidates into the list of predictor candidates, wherein a single dimension attribute comprises a reflection, wherein a predictor candidate comprises a multiple dimensions attribute prediction, and
wherein determining whether to add a potential candidate into the list of predictor candidates:
if a comparison of at least one dimension of multiple dimensions between the potential candidate and a candidate in the list of predictor candidates indicates that the potential candidate is identical to or similar to the candidate in the list of predictor candidates, determining not to add the potential candidate into the list of predictor candidates, wherein a predictor candidate comprises a multiple dimensions attribute prediction, and
wherein determining whether to add a potential candidate into the list of predictor candidates:
if a comparison of multiple dimensions among a plurality of candidates indicates that attribute values of the plurality of candidates are equal, determining to add one of the plurality of candidates into the list of predictor candidates, wherein a multiple dimensions attribute comprises a color.

8. The method of claim 1, further comprising:
determining a real maximum candidate index of a prediction list of a current point of the current frame; and
including the real maximum candidate index in the bitstream, wherein the conversion is performed based on the including.

9. The method of claim 8, wherein determining the real maximum candidate index comprises:
determining the real maximum candidate index based on at least one of:
a number of points in the prediction list,
a maximum number of single point predictors used for direct prediction, or
an indicator of whether a point predictor set average being a direct prediction mode, wherein the real maximum candidate index is determined by using the following:
$$maxCanIdx = min ( N , pred\_direct \_max \_idx ) + ! pred\_direct \_avg \_disabled \_flag ,$$
wherein maxCanIdx represents the real maximum candidate index, N represents the number of points in the prediction list, pred_direct_max_idx represents the maximum number of single point predictors used for direct prediction, pred_direct_avg_disabled_flag represents the indicator of whether a point predictor set average being a direct prediction mode, and min( ) represents a function to obtain a minimum value, wherein determining the real maximum candidate index comprises:
if predictor candidates in the prediction list are created with a pruning process, determining the real maximum candidate index by subtracting a predefined value from a number of predictor candidates, wherein the predefined value comprises 1, wherein including the real maximum candidate index in the bitstream comprises:
determining a bit length of a fixed-length coding based on the real maximum candidate index; and
including the real maximum candidate index in the bitstream by using the fixed-length coding, wherein including the real maximum candidate index in the bitstream comprises:
determining a minimum value of a truncated unary coding based on the real maximum candidate index; and
including the real maximum candidate index in the bitstream by using the truncated unary coding, wherein including the real maximum candidate index in the bitstream comprises:
including the real maximum candidate index with other signals in the bitstream, wherein the other signals comprises attribute residuals.

10. The method of claim 1, further comprising:
determining a selected neighbor point of a current point of the current frame; and
determining a predicted attribute of the current point based on an attribute of the selected neighbor point, wherein the conversion is performed based on the predicted attribute.

11. The method of claim 10, wherein determining the selected neighbor point comprises:
determining the selected neighbor point by searching a set of candidate search points, wherein determining the selected neighbor point by searching a set of candidate search points comprises:
determining a candidate search point with a minimum distance to the current point as the selected neighbor point, wherein searching the set of candidate search points is based on one of the following:
a Euclidean distance,
a Manhattan distance, or
a Chebyshev distance, wherein determining the selected neighbor point comprises:
selecting the selected neighbor point from a set of points in the bitstream.

12. The method of claim 1, further comprising:
determining a prediction list of a current point of the current frame;
determining a set of predictor candidates of the current point by obtaining a value set based on attributes of points in the prediction list; and
determining respective predictor indexes for the set of predictor candidates, wherein the conversion is performed based on the set of predictor candidates.

13. The method of claim 12, wherein determining the set of predictor candidates of the current point by obtaining the value set based on attributes of points in the prediction list comprises:
obtaining outputs of a metric based on the attributes of points in the prediction list as the value set; and
determining the value set as the set of predictor candidates, wherein the metric comprises a median metric, wherein a value in the value set is used as a predictor candidate of the current point, wherein a predictor index of the current point refers to a value in the value set, wherein the predictor index is a non-negative integer.

14. The method of claim 13, further comprising:
if predictor candidates of the current point created with a pruning process, determining a real maximum candidate index by subtracting an integer from a number of the predictor candidates, wherein the integer comprises 1.

15. The method of claim 1, further comprising:
determining a neighbor point of a current point of the current frame; and
determining a weighted average value of the neighbor point and an opposite point of the neighbor point as a predictor candidate of the current point, the opposite point being in a direction range opposite to a direction range of the neighbor point, wherein the conversion is performed based on the predictor candidate.

16. The method of claim 15, further comprising:
determining a predictor index for the predictor candidate, the predictor index being different from a further predictor index of a further predictor candidate of the current point, wherein the neighbor point comprises a nearest neighbor point of the current point, wherein determining a weighted average value of the neighbor point and an opposite point comprises:
determining a first weight of the neighbor point based on a first distance between the neighbor point and the current point;
determining a second weight of the opposite point based on a second distance between the opposite point and the current point; and
determining the weighted average value based on the first and second weights, wherein the first and second distances are determined by using one of the following:
a Euclidean distance,
a Manhattan distance, or
a Chebyshev distance,
wherein the Euclidean distance between a first point (x₁, y₁, z₁) and a second point (x₂, y₂, z₂) is determined by using the following:
$$d = \sqrt{{a ( {x}_{1} - {x}_{2} )}^{2} + {b ( {y}_{1} - {y}_{2} )}^{2} + {c ( {z}_{1} - {z}_{2} )}^{2}} ,$$
where a, b and c are factors representing importance of different dimensions,
wherein the Manhattan distance between a first point (x₁, y₁, z₁) and a second point (x₂, y₂, z₂) is determined by using the following:
$$d = a \vert {x}_{1} - {x}_{2} \vert + b \vert {y}_{1} - {y}_{2} \vert + c \vert {z}_{1} - {z}_{2} \vert ,$$
where a, b and c are factors representing importance of different dimensions,
wherein the Chebyshev distance between a first point (x₁, y₁, z₁) and a second point (x₂, y₂, z₂) is determined by using the following:
$$d = max ( a \vert {x}_{1} - {x}_{2} \vert , b \vert {y}_{1} - {y}_{2} \vert , c \vert {z}_{1} - {z}_{2} \vert ) ,$$
where a, b and c are factors representing importance of different dimensions, and max( ) represents a metric that obtain a maximum of three values,
wherein the weighted average value is used as a predictor of the current point, wherein a predictor index of the current point refers to the weighted average value, wherein the predictor index is a non-negative integer, wherein if predictor candidates of the current point are created with a pruning process, the predictor index is a positive integer.

17. The method of claim 1, wherein the conversion includes encoding the current frame into the bitstream, or wherein the conversion includes decoding the current frame from the bitstream.

18. An apparatus for processing point cloud data comprising a processor and a non-transitory memory with instructions thereon, wherein the instructions upon execution by the processor, cause the processor to
determine, during a conversion between a current frame of a point cloud sequence and a bitstream of the point cloud sequence, first information comprising at least one of: at least one neighbor list comprising a set of neighbor points of a current point of the current frame based on geometry information of the set of neighbor points, a list of predictor candidates of a current point of the current frame, a real maximum candidate index of a prediction list of a current point of the current frame, a selected neighbor point of a current point of the current frame, a prediction list of a current point of the current frame, or a neighbor point of a current point of the current frame; and
perform the conversion based on the first information.

19. A non-transitory computer-readable storage medium storing instructions that cause a processor to perform a method performed by a point cloud processing apparatus, wherein the method comprises:
determining, during a conversion between a current frame of a point cloud sequence and a bitstream of the point cloud sequence, first information comprising at least one of: at least one neighbor list comprising a set of neighbor points of a current point of the current frame based on geometry information of the set of neighbor points, a list of predictor candidates of a current point of the current frame, a real maximum candidate index of a prediction list of a current point of the current frame, a selected neighbor point of a current point of the current frame, a prediction list of a current point of the current frame, or a neighbor point of a current point of the current frame; and
performing the conversion based on the first information.

20. A non-transitory computer-readable recording medium storing a bitstream of a point cloud sequence which is generated by a method performed by a point cloud processing apparatus, wherein the method comprises:
determining first information comprising at least one of: at least one neighbor list comprising a set of neighbor points of a current point of a current frame of the point cloud sequence based on geometry information of the set of neighbor points, a list of predictor candidates of a current point of the current frame, a real maximum candidate index of a prediction list of a current point of the current frame, a selected neighbor point of a current point of the current frame, a prediction list of a current point of the current frame, or a neighbor point of a current point of the current frame; and
generating the bitstream based on the first information.
